(19) United States
(12) Patent Application Publication
(10) Pub. No.: US 2010/0159778 A1
(43) Pub. Date: Jun. 24, 2010

(54) CONFORMABLE ATTACHMENT STRUCTURE FOR FORMING A SEAL WITH THE SKIN

(76) Inventors: Janis W. Hughes, Alpharetta, GA (US); Bryon P. Day, Canton, GA (US); Russell F. Ross, Atlanta, GA (US); Lisa M. Sanabria, Alpharetta, GA (US)

Correspondence Address: KIMBERLY-CLARK WORLDWIDE, INC.;Tara Pohlkotte, 2300 Winchester Rd., NEENAH, WI, 54956, US

(21) Appl. No.: 12/343,657

(22) Filed: Dec. 24, 2008

(51) Int. Cl. D04H 1/54; B32B 3/26

(52) U.S. Cl. 442/400; 428/343; 428/317.3

(57) ABSTRACT

The present invention is directed to an article suitable for attachment to the skin of a user, the article including a compressible material and a means for attaching the compressible material to skin, wherein the compressible material has Compressibility under a 1.4 kilopascal load greater than about 14 percent, and further wherein the compressible material has an Initial Shear Modulus in a first direction less than about 200 kilopascals.

### BACKGROUND OF THE INVENTION

There are many products that contact or attach to a person's skin during use of the product. For example, face masks fit over the face to form a seal against particles or gases passing between the face mask and the skin. Personal care products such as diapers, training pants, incontinence products, and feminine care products desirably form a seal against leakage of bodily fluids between the product and the skin. Bandages attach to the skin to form a seal against contaminants reaching a wound by passing between the bandage and the skin.

Products attached directly to the body desirably maintain a good seal with the skin during a multitude of body movements. For example, movement of the underlying skin should not cause disruption of the seal, that is, movement should not cause bunching or gapping at the surface of the skin that would allow passage of bodily fluids or contaminants. Additionally, movement of the product caused by movement of the underlying skin can affect the performance of the product. Accordingly, there is a need for a material for attaching to and forming a seal against skin that can withstand movement of the underlying skin without excessive bunching, sagging, or drooping of the material.

### SUMMARY OF THE INVENTION

In accordance with one embodiment of the present invention, a conformable skin-attachment structure for forming a seal with skin is provided. The conformable attachment structure comprises an external body-facing compressible layer and a means for attaching the compressible layer to skin. The compressible layer has Compressibility, as defined below, under a 1.4 kilopascal load greater than about 14 percent. Further, the compressible layer has an Initial Shear Modulus, as defined below, in a first direction less than about 200 kilopascals. In some embodiments, the compressible layer may have an Initial Shear Modulus in a second direction transverse to the first direction less than about 200 kilopascals. In other embodiments, the compressible layer may have an Extensibility, as defined below, in the first direction greater than about 20 percent. In further embodiments, the compressible layer may have a Tensile Force @ 20 percent extension, as defined below, in the first direction less than about 500 grams-force.

In some embodiments, the compressible layer may be selected, for example, from the group consisting of woven fabrics, nonwoven fabrics, including meltblown and spunbond nonwoven fabrics, and foams.

In some embodiments, the compressible layer is attached to a support layer. The support layer may be selected, for example, from spunbond nonwovens, meltblown nonwovens, films, absorbents, laminates thereof, and so forth.

In some embodiments, the means for attaching the compressible layer to skin may include adhesive hairs. The adhesive hairs may have, for example, a length from about 0.5 microns to about 8 millimeters and a diameter from about 0.1 microns to about 50 microns.

In some embodiments, the means for attaching the compressible layer to skin may include a skin adhesive.

In accordance with another embodiment of the present invention, a conformable attachment structure for forming a seal with skin is provided. The conformable attachment structure includes an external body-facing compressible attachment layer and a support layer. The external body-facing compressible attachment layer includes at least one layer with Extensibility in a first direction between about 20% and about 2000%, an Initial Shear Modulus in the first direction between about 10 and about 200 kilopascals, and Compressibility under a 1.4 kilopascal load between about 14 and about 80 percent. The support layer may be, for example, a spunbond nonwoven, a meltblown nonwoven, a polymeric film, laminates thereof, and so forth. In one embodiment, the support layer is a spunbond-meltblown-spunbond nonwoven laminate.

In one embodiment, the compressible attachment layer includes a meltblown nonwoven fabric. The meltblown nonwoven fabric may be isotropic with respect to the Initial Shear Modulus in the first direction and Initial Shear Modulus in a second direction transverse to the first direction.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a partial cross-sectional side view of a compressible material for forming a seal with the skin in accordance with one embodiment of the present invention; and

FIG. 2 is a perspective view of a personal care product that may be formed in accordance with one embodiment of the present invention.

Repeat use of reference characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment may be used on another embodiment to yield a still further embodiment. Thus, it is intended that the present invention cover such modifications and variations.

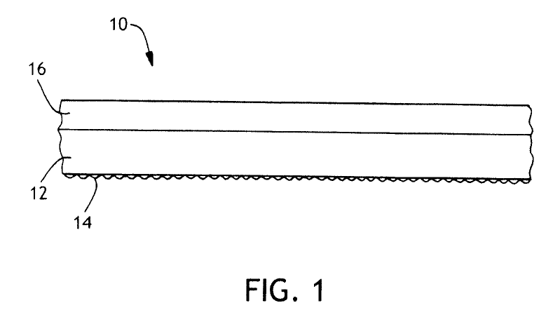

The present invention is generally directed to an article suitable for attachment to the skin of a user. The article 10, depicted in FIG. 1, includes a compressible material 12 and means for attaching the compressible material to skin 14. Suitably the article is arranged in layers, with the means for attaching the compressible material to skin 14 being an outermost layer and the compressible material 12 being attached directly or indirectly to the skin attachment means 14. The article may further include one or more additional support or functional layers 16.

The compressible material 12 is desirably adapted to move with the skin to prevent buckling, gapping, and bunching of the article 10 that may negatively impact either the seal of the compressible material against the skin or the function of the overlying functional layers. Desirably, the compressible material will absorb the stresses and strains imposed on it by the surface of the underlying skin during normal body motion and thus stay in close contact with the skin.

Desirably the compressible material 12 is extensible. Extensibility of the compressible material allows the compressible material to move or stretch as the underlying skin moves. Materials with low Extensibility will restrict skin movement or, alternatively, release from and slide over the skin. Desirably, the Extensibility, measured as described below, of the compressible material in a first direction is greater than about 20 percent, or, alternatively, between about 20 percent and about 2000 percent. The first direction as used herein may coincide with either the machine direction (MD) or cross direction (CD). As used herein, the term “machine direction” means the direction along the length of a material, fabric or other web or film in the direction in which it is produced. The term “cross direction” means the direction across the width of material, i.e. a direction generally perpendicular to the MD.

More desirably, the Extensibility of the compressible material in a direction transverse to the first direction is greater than about 20 percent, or, alternatively, between about 20 percent and about 2000 percent. Even more desirably, the Extensibility of the compressible materials is greater than about 20 percent in both the first direction and the direction transverse to the first direction, or, alternatively, between about 20 percent and about 2000 percent in both the first direction and the direction transverse to the first direction. It is also desirable if the compressible material is isotropic in the first and second directions with respect to Extensibility. By isotropic it is meant that a property in the first and second directions is within 10 percent of the average of both directions.

Desirably the compressible material 12 exhibits an Initial Shear Modulus in a first direction, measured as described below, less than about 200 kilopascals, or, alternatively, between about 10 and about 200 kilopascals. In some embodiments the first direction coincides with the material's machine direction, or, alternatively, the material's cross direction. More desirably, the Initial Shear Modulus in a direction transverse to the first direction is also less than about 200 kilopascals, or, alternatively, between about 10 and about 200 kilopascals. In another embodiment, the compressible material exhibits an Initial Shear Modulus in a first direction less than about 150 kilopascals, or, alternatively, between about 20 and about 150 kilopascals. More desirably, the Initial Shear Modulus in a direction transverse to the first direction is also less than about 150 kilopascals, or alternatively, between about 20 and about 150 kilopascals. The relatively low Initial Shear Modulus permits the compressibility material to stretch with minimal force to minimize or prevent disengagement of the attachment means from the skin. Materials with higher Initial Shear Modulus than the skin will restrict movement and may cause gaps to form between the skin and the material. It is also desirable if the compressible material is isotropic in the first and second directions with respect to Initial Shear Modulus.

Desirably the compressible material 12 exhibits a Tensile Force @ 20 percent extension in a first direction, measured as described below, less than about 500 grams-force, or, alternatively, between about 50 and about 500 grams-force. In some embodiments the first direction coincides with the material's machine direction, or, alternatively, the material's cross direction. More desirably, the Tensile Force @ 20 percent extension in a direction transverse to the first direction is also less than about 500 grams-force, or, alternatively, between about 50 and about 500 grams-force. In another embodiment, the compressible material exhibits a Tensile Force @ 20 percent extension in a first direction less than about 250 grams-force, or, alternatively, between about 100 and 250 grams-force. More desirably, the Tensile Force @ 20 percent extension in a direction transverse to the first direction is also less than about 250 grams-force, or alternatively, between about 100 and about 250 grams-force. The relatively low Tensile Force @ 20 percent extension permits the compressibility material to stretch to a greater extent with minimal force to minimize or prevent disengagement of the attachment means from the skin. Materials with higher Tensile Force @ 20 percent extension than the skin will restrict movement to a greater extent and may be more prone to cause gaps to form between the skin and the material. It is also desirable if the compressible material is isotropic in the first and second directions with respect to Tensile Force @ 20 percent extension.

Desirably the compressible material 12 exhibits a Compressibility (under a 1.4 kilopascal load), measured as described below, greater than about 14 percent, or, alternatively, between about 14 percent and about 80 percent. The Compressibility permits the compressible material to absorb motion of the underlying skin rather than transmit the motion to the overlying functional layers. Additionally, materials with lower Compressibility tend to buckle away from the surface of the skin, thereby causing gaps to form between the material and the skin.

The compressible material 16 may be, for example, a foam, nonwoven fabric, woven fabric, or laminates thereof. The term “nonwoven fabric” generally refers to a web having a structure of individual fibers or threads which are interlaid, but not in an identifiable manner as in a knitted fabric, which would be generally referred to as a “woven fabric”. Examples of suitable nonwoven fabrics include, but are not limited to, spunbond, meltblown, spunbond-meltblown laminate, spunbond-meltblown-spunbond laminate, bonded card webs, coform materials, hydroentangled webs and laminates thereof, etc. The term “meltblown” generally refers to a nonwoven web that is formed by a process in which a molten thermoplastic material is extruded through a plurality of fine, usually circular, die capillaries as molten fibers into converging high velocity gas (e.g., air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that are substantially continuous or discontinuous, generally smaller than 10 microns in diameter, and generally tacky when deposited onto a collecting surface. The term “spunbond web” generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond fibers are generally not tacky when they are deposited onto a collecting surface. Spunbond fibers may sometimes have diameters less than about 40 microns, and are often between about 5 to about 20 microns.

The basis weight of the compressible material may generally vary, such as from about 10 grams per square meter (“gsm”) to 300 gsm, in some embodiments from about 20 gsm to about 200 gsm, and in some embodiments, from about 25 gsm to about 150 gsm.

The skin attachment means 14 holds the compressible material 12 against the skin of the user. Various means for attachment to the skin known to those skilled in the art may be used, including, for example, pressure sensitive adhesives, skin adhesives, glues and so forth. When an adhesive is used, the degree of tackiness may be selected depending on the application, the surface area of the article in contact with the skin as well as the presence or absence of other means for holding the article in place. The skin attachment means is attached directly to the compressible material 12, as intervening substrate layers may inhibit the functionality of the compressible material. In one embodiment, the skin attachment means may be gecko-like adhesive hairs such as described in patent application US2005/0148984 to Lindsay et al., the contents of which are incorporated by reference herein for all purposes. For example, the gecko-like adhesive hairs may be generally cylindrical with a diameter (or range of diameters throughout a given hair) and a height or length, and extend by the height or length from the compressible material 12. The height or length of the adhesive hairs extending from the compressible material 12 may be from about 0.5 microns to about 8 millimeters, such as from about 2 microns to about 1000 microns, more specifically from about 2 microns to about 500 microns, more specifically still from about 4 microns to about 200 microns, and most specifically from about 5 microns to about 100 microns. The diameter of the adhesive hairs may be greater than about 0.05 microns or from or from about 0.1 microns to about 50 microns, such as from about 0.1 microns to about 10 microns, more specifically from about 0.2 microns to about 5 microns, more specifically still from about 0.2 microns to about 2 microns, and most specifically from about 0.3 microns to about 1 microns, or alternatively less than about 5 microns or less than about 3 microns. The adhesive hairs may be present in a density ranging from about 1 hair per square micron to about 1 hair per 1,000,000 square microns, specifically from about 1 hair per square micron to about 1 hair per 10,000 square microns, more specifically from about 1 hair per square micron to about 1 hair per 1,500 square microns, and most specifically from about 1 hair per 4 square microns to about 1 hair per 1,000 square microns.

The optional support or functional layer 14 may be, for example, a film, foam, nonwoven fabric, woven fabric, or laminates thereof. The basis weight of the optional support or functional layer may generally vary, such as from about 0.1 grams per square meter (“gsm”) to 200 gsm, in some embodiments from about 0.5 gsm to about 100 gsm, and in some embodiments, from about 1 gsm to about 35 gsm. The one or more optional support or functional layer 14, when present, is laminated to a side of the compressible material that opposes the side adapted for skin contact. The support or functional layer may be attached or laminated to the compressible material by methods known to those skilled in the art, for example, with glue, adhesive, thermal bonds, ultrasonic bonds, and so forth.

Desirably, the optional support or functional layer 14 is less extensible than the compressible layer, so as to resist extension of the support or functional layer in the event such forces are transmitted through the compressible layer 12. In one embodiment, the extensibility of the functional layer in a first direction is less than about 20 percent, or, alternatively, between about 2 percent and about 20 percent. Even more desirably, the extensibility of the functional layer in a direction transverse to the first direction is less than about 20 percent, or, alternatively, between about 2 percent and about 20 percent. Most desirably, the extensibility of the functional layer is less than about 20 percent in both the first direction and the direction transverse to the first direction, or, alternatively, between about 2 percent and about 20 percent in both the first direction and the direction transverse to the first direction.

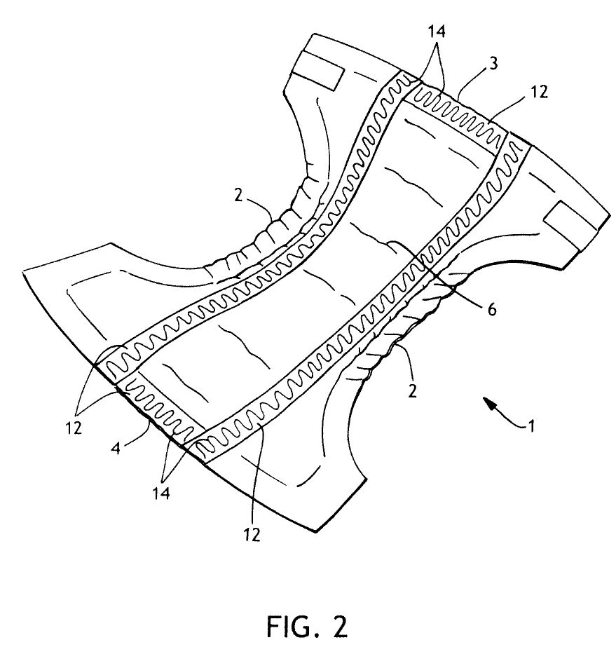

When used in a disposable personal care article the compressible material 12 and skin attachment means 14 are desirably located on the article as a perimeter sealing component. As shown in FIG. 2, in the case, for example, of a diaper 1, having leg cuffs 2, a waistband in front 3 and rear 4, and a central absorbent portion 6, a compressible material 12 having there on a skin attachment means 14 as described above is attached to the diaper 1 and arranged as a perimeter sealing component. Similar features may be found in disposable swimwear, training pants, adult incontinence items, and feminine hygiene articles. The compressible material 12 having there on a skin attachment means 14 are arranged to seal against the skin to hold waste within the diaper and prevent soiling of the wearer's clothing. To improve attachment of the skin attachment means 14 to skin, the compressible material 10 is attached to the perimeter sealing component so as to leave the skin attachment means 14 exposed. When worn by a user, the skin attachment means 14 will attach and seal against the wearer's skin, and the compressible material 12 will aid in maintaining a good, comfortable seal as the wearer moves.

In one embodiment, the compressible material 12 and skin attachment means 14 are located on the areas of a respirator or face mask most likely to contact the face of a wearer, generally the edges or periphery of the mask, in order to improve adhesion with the face and create and maintain a better seal against the face. Facemasks and respirators may be used in, for example, medical, industrial, commercial, or residential applications. While the applications may be varied, the common purpose is generally to prevent the entry of dust, particles, liquids, and other contaminants into the mask so that they will not contact the skin or be breathed by a wearer.

Test Methods

Thickness/Compressibility (percent): Ten (10) layers of the material to be tested were cut to approximately 10.2 centimeters by 10.2 centimeters and stacked on top of each other flatly. The original thickness (bulk) of the stack was measured with a low-tension caliper (Absolute ID-S1012 Digimatic Indicator, available from Mitutoyo Corporation of Aurora, Ill.) by holding the calipers upright, pushing the trigger to raise the bulk probe, inserting the sample, and releasing the trigger slowly to allow the probe to rest on the upper surface of the stack with a minimal amount of pressure. The reading is repeated five (5) times on different areas of the stack, and the average thickness is calculated. A bulk test stand was used to measure compressed bulk (Digimatic Indicator, model number IDF-130E, available from Mitutoyo Corporation of Aurora, Ill.). The bulk probe (round, 7.5 centimeters in diameter, 15 mm thick, weighted for 1.4 kilopascals applied pressure) was lowered to the test stand surface, and the measurement device was zeroed. Then the probe was lifted, the stack of material to be tested was placed flat underneath the probe, and the probe was applied to the surface of the material with 1.4 kilopascals of pressure. The probe was allowed to stabilize for 20 seconds, and the compressed thickness (bulk) of the stack was recorded from the device. The measurement was repeated five (5) times and the average value was calculated. The original thickness and compressed thickness under 1.4 kilopascals load were used to calculate the bulk compressibility (percent) as follows:

(original thickness−compressed thickness)/original thickness*100%

Extensibility/Tensile Force @ 20% extension: Samples were cut in the form of strips 17.8 centimeters long by 7.6 centimeters wide. One set of samples was prepared in which the long dimension (17.8 centimeters, the direction in which the test is performed) coincided with the material's machine direction. Another set of samples was prepared in which the long dimension coincided with the material's cross direction. The strips were clamped securely in the jaws of a Material Testing System (MTS) Sintech 1/S tensile testing frame with the longer dimension of the sample spanning between the jaws. A grip to grip distance of 7.6 centimeters was used in all tests, and the grips were 7.6 centimeters wide with smooth surface jaws. The samples were displaced at a rate of 8.5 millimeters per second via the cross-head movement while tensile force and displacement (elongation/extension) were recorded. The samples were pulled to twice their original length (100% extension) or until the sample breaks, whichever came first. The tensile force at 20 percent elongation (1.52 centimeters displacement of the jaws) was obtained from the recorded data. Extensibility (percentage), the displacement of the jaws when the sample breaks or the maximum displacement the jaws reach during the test without the sample breaking (7.6 centimeters at test completion), whichever is less, multiplied by 100 and divided by the initial distance between the jaws (7.6 centimeters), was also obtained from the recorded data.

Initial Shear Modulus: To calculate Initial Shear Modulus, The tensile force data obtained as described above was converted to units of stress by dividing the tensile force by the sample initial cross-sectional area. The initial cross-sectional area was calculated as the initial thickness (obtained as described above) times the width of the sample (7.6 centimeters, as defined above). The calculated stresses were plotted on the y-axis versus (alpha−(1/alpha²)) on the x-axis where alpha for each stress value is equal to the associated distance between the jaws divided by the initial distance between the jaws (7.6 centimeters). The Initial Shear Modulus is then calculated by performing a least squares linear regression on the stress versus (alpha−(1/alpha²)) data for all the data where alpha is less than or equal to 0.1. Data where alpha is greater than 0.1 is excluded from the regression so as to provide an initial shear modulus.

### EXAMPLES

Several foams have been identified as suitable compressible materials:

Foam #1: Foam #1 is a polyether polyurethane foam (E55, Vita Interfoam of Luxemburg. Foam #1 is hydrophilic and has an approximate density of 50 kg/m̂3.

Foam #2: Foam #2 is a 1.5 millimeter thickness, high grade polyurethane foam with anti-bacterial, anti-UV, and anti-ion treatments. It was obtained from The Penthouse Group of Freeport, N.Y.

Meltblown: A meltblown web was formed having a basis weight of 135 grams per square meter. The composition of the meltblown web was 64 percent by weight styrene-ethylene-butylene-styrene (SEBS) styrenic block copolymer (KRATON® MD6937, Kraton Polymers, LLC of Houston, Tex.), 20 percent by weight polypropylene (PP3505, ExxonMobil Chemical Company of Houston, Tex.), and 16 percent by weight polyethylene wax (AFFINITY® GA1900, The Dow Chemical Company, Midland, Mich.). The polymers were measured by weight, and the pellets or crumbs were dry blended by stirring together. They were then introduced into an extruder and processed through a conventional meltblown die to form fibers on a moving foraminous wire with vacuum underneath.

Properties for the sample materials, measured as described above, are provided in Table 1.

TABLE 1
Sample properties

| | | Initial | Tensile | Tensile | | | |
|---|---|---|---|---|---|---|---|
| | Initial | Shear | Force at | Force at | | | |
| | Shear | Modulus | 20% | 20% | | | |
| | Modulus | MD | extension | extension | Extensibility | Extensibility | Compressibility |
| Sample | CD (kPa) | (kPa) | CD (gf) | MD (gf) | (percent) | (percent) | (percent) |
| Foam #1 | 30.7 | 41.7 | 160 | 209 | 100 | 100 | 67 |
| Foam #2 | 25.0 | 77.7 | 315 | 725 | 100 | 100 | 67 |
| Meltblown | 135 | 137 | 216 | 222 | 100 | 100 | 15 |

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A conformable skin-attachment structure for forming a seal with skin, the conformable attachment structure comprising an external body-facing compressible layer and a means for attaching the compressible layer to skin, wherein the compressible layer has Compressibility under a 1.4 kilopascal load greater than about 14 percent, and further wherein the compressible layer has an Initial Shear Modulus in a first direction less than about 200 kilopascals.

2. The conformable skin-attachment structure of claim 1, wherein the compressible layer is a selected from the group consisting of woven fabrics, nonwoven fabrics, and foams.

3. The conformable skin-attachment structure of claim 1, wherein the compressible layer is a meltblown nonwoven fabric.

4. The conformable skin-attachment structure of claim 1, wherein the compressible layer has Initial Shear Modulus in a second direction transverse to the first direction less than about 200 kilopascals.

5. The conformable skin-attachment structure of claim 1, wherein the compressible layer has Extensibility in the first direction greater than about 20 percent.

6. The conformable skin-attachment structure of claim 1, wherein the compressible layer has a Tensile Force @ 20 percent extension in the first direction less than about 500 grams-force.

7. The conformable skin-attachment structure of claim 1, wherein the compressible layer is attached to a support layer comprising a substantially nonextensible layer selected from the group consisting of spunbond nonwoven, meltblown nonwoven, films, and laminates thereof.

8. The conformable skin-attachment structure of claim 1, wherein the support layer comprises an absorbent layer.

9. The conformable skin-attachment structure of claim 1, wherein the means for attaching the compressible layer to skin comprises adhesive hairs.

10. The conformable skin attachment structure of claim 9, wherein the adhesive hairs have a length from about 0.5 microns to about 8 millimeters and a diameter from about 0.1 microns to about 50 microns.

11. The conformable skin-attachment structure of claim 1, wherein the means for attaching the compressible layer to skin comprises a skin adhesive.

12. An article suitable for attachment to the skin of a user, the article comprising a compressible material and a means for attaching the compressible material to skin, wherein the compressible material has Compressibility under a 1.4 kilopascal load greater than about 14 percent, and further wherein the compressible material has an Initial Shear Modulus in a first direction less than about 200 kilopascals.

13. The article of claim 12, further comprising a functional layer positioned on a side of the compressible material opposite the means for attaching the compressible material to skin.

14. The article of claim 12, wherein the compressible material has Extensibility in a first direction greater than about 20 percent.

15. The article of claim 14, wherein the compressible material has Extensibility in a second direction transverse to the first direction greater than about 20 percent.

16. The conformable skin-attachment structure of claim 12, wherein the compressible material has an Initial Shear Modulus in a second direction transverse to the first direction less than about 200 kilopascals.

17. A conformable attachment structure for forming a seal with skin, the conformable attachment structure comprising an external body-facing compressible attachment layer and a support layer, the external body-facing compressible attachment layer comprising at least one layer with Extensibility in a first direction between about 20% and about 2000%, Initial Shear Modulus in the first direction between about 10 and about 200 kilopascals, and Compressibility under a 1.4 kilopascal load between about 14 and about 80 percent, and the support layer being selected from the group consisting of spunbond nonwoven, meltblown nonwoven, polymeric films, and laminates thereof.

18. The conformable attachment structure of claim 17, wherein the support layer is a spunbond-meltblown-spunbond nonwoven laminate.

19. The conformable attachment structure of claim 17, wherein the compressible attachment layer comprises a meltblown nonwoven fabric.

20. The conformable attachment structure of claim 19, wherein the meltblown nonwoven fabric is isotropic with respect to the Initial Shear Modulus in the first direction and Initial Shear Modulus in a second direction transverse to the first direction.
